(19) United States
(12) Patent Application Publication
(10) Pub. No.: US 2017/0134097 A1
(43) Pub. Date: May 11, 2017

(54) OPTICAL RECEIVER AND OPTICAL RECEIVING METHOD

(71) Applicant: NEC Corporation, Tokyo (JP)

(72) Inventor: Masao MORIE, Tokyo (JP)

(73) Assignee: NEC Corporation, Tokyo (JP)

(21) Appl. No.: 15/317,928

(22) PCT Filed: Jun. 10, 2015
(86) PCT No.: PCT/JP2015/002909

§ 371 Date: Dec. 9, 2016

(30) Foreign Application Priority Data
Jun. 12, 2014 (JP) 2014-121490

(51) Int. Cl. H04B 10/61; H04B 10/079; G01J 1/44

(52) U.S. Cl. CPC H04B 10/61; G01J 1/44; H04B 10/07955

(57) ABSTRACT

In order to precisely know the light power of a received signal in a wide light input power range, a light reception device comprises: a reception unit that receives a coherent-modulated signal light and outputs a first electric signal to which the signal light has been converted; an amplification unit that amplifies the first electric signal and outputs the amplified electric signal as a second electric signal; and a control unit that determines the light power of the signal light on the basis of a relationship between the light power of the signal light in the reception unit and at least one of the gain of the amplification unit and the amplitude of the second electric signal.

### TECHNICAL FIELD

The present invention relates to an optical receiver, an optical receiving method and a control program of an optical receiver, and more particularly, to an optical receiver, an optical receiving method and a control program of an optical receiver that are used in a coherent optical transmission system.

### BACKGROUND ART

Practical use of a coherent optical transmission system which enables large capacity and high-speed communication is being advanced. In a coherent optical transmission system, a coherent optical receiver is used to demodulate an optical signal. In a coherent optical receiver, received signal light (a reception beam) and a LO (local oscillation) beam having an optical frequency approximately identical with that of the reception beam are combined by an optical mixer called a 90-degree hybrid. Output of a 90-degree hybrid is received by a PD (a photo diode). The PD outputs a beat signal caused between the reception beam and the LO light to a differential amplifier as photo electric current. The differential amplifier converts photocurrent outputted by the PD into a voltage signal and outputs the voltage signal to an ADC (analog-digital converter). The beat signal converted into a digital signal in the ADC is outputted to DSP (digital signal processor). The DSP performs calculation processing of the digital signal outputted from ADC to reproduce transmitted data.

Related to the present invention, there is disclosed in patent literature (PTL) 1 a frequency control method having a function for holding the frequency of LO light to a numerical value just before detection of a cut off of an input signal. In PTL 2, there is disclosed a light reception circuit having a function for generating an input interruption alarm signal only at the time of an optical input interruption.

### CITATION LIST

### Patent Literature

[PTL 1] Japanese Patent Application Laid-Open No. 1993-308325 (paragraph [0013])

[PTL 2] Japanese Patent Application Laid-Open No. 1990-105643 (page 3, lower right column to page 4, lower right column)

### SUMMARY OF INVENTION

### Technical Problem

In an optical receiver to receive a wavelength-multiplexed signal, only a reception beam of a selected wavelength can be received by a monitor PD by selecting by an optical filter a reception beam (reception channel) of the wavelength to be received. By such structure, input power and LOS (loss of signal) only of the reception beam in the reception channel can be detected.

In contrast, in a coherent optical receiver, it is possible to receive only a reception beam of a wavelength that generates a beat signal with LO light as an electric signal. For this reason, an optical filter for selecting a reception channel is not needed for a coherent optical receiver necessarily. However, a coherent optical receiver which does not have an optical filter for selecting a reception channel cannot select a reception beam in a reception channel by an optical filter, and, therefore, its optical power cannot be measured and LOS cannot be detected.

It is also possible to measure the optical power of a reception channel based on the amplitude of an electric signal converted from an optical signal in the reception channel. An automatic frequency control method disclosed in PTL 1 is equipped with a structure for suppressing a fluctuation of a frequency of LO light even if a temporary optical input interruption occurs. However, there is disclosed no structure for detecting the optical power of a reception beam in patent document 1. A light reception circuit disclosed in patent document 2 is equipped with a structure to generate an input interruption alarm based on a gain of a variable gain amplifier circuit which amplifies a received signal. However, in the structure of patent document 2, the optical power of a received signal cannot be detected correctly when an amplifier circuit is operating outside its dynamic range.

### OBJECT OF INVENTION

An object of the present invention is to provide an optical receiver, an optical receiving method and a control program of an optical receiver which can detect the optical power of a received signal correctly in a wide range of optical input power without needing an optical filter.

### Solution to Problem

An optical receiver of the present invention includes: reception means for receiving an optical signal having undergone coherent modulation to output a first electric signal converted from the optical signal; amplifying means for amplifying the first electric signal to output the first electric signal having been amplified as a second electric signal; and control means for obtaining an optical power of the optical signal based on relation between optical power of the optical signal in the reception means and at least one of a gain of the amplifying means and amplitude of the second electric signal.

An optical receiving method of the present invention includes: receiving an optical signal having undergone coherent modulation; outputting a first electric signal converted from the optical signal; amplifying the first electric signal; outputting the first electric signal having been amplified as a second electric signal; and obtaining an optical power of the optical signal based on relation between optical power when receiving the optical signal, and at least one of a gain when amplifying the first electric signal and amplitude of the second electric signal.

A control program of an optical receiver of the present invention makes a computer of the optical receiver carry out: a procedure to receive an optical signal having undergone coherent modulation; a procedure to output a first electric signal converted from the optical signal; a procedure to amplify the first electric signal; a procedure to output the first electric signal having been amplified as a second electric signal; and a procedure to obtain optical power of the optical signal based on relation between optical power when receiving the optical signal, and at least one of a gain when amplifying the first electric signal and amplitude of the second electric signal.

### Advantageous Effect of Invention

An optical receiver, an optical receiving method and a control program of an optical receiver of the present invention can detect the optical power of a received signal correctly in a wide range of optical input power.

### BRIEF DESCRIPTION OF DRAWINGS

FIG. 1 is a block diagram showing a structure of a coherent optical receiver of a first example embodiment.

FIG. 2 is a block diagram showing a structure of a differential amplifier.

FIG. 3 is a diagram showing an example of relation between optical input power Pin and gain A of an AGC amplifier.

FIG. 4 is a diagram showing an example of relation between optical input power Pin and amplitude V of an output signal of a differential amplifier.

FIG. 5 is a flow chart showing a procedure to obtain optical input power Pin in a control circuit.

FIG. 6 is a diagram showing an example of relation between optical input power Pin, amplitude V, a gain A and V/A.

FIG. 7 is a block diagram showing a structure of a coherent optical receiver which is a modified example of the first example embodiment.

### DESCRIPTION OF EMBODIMENTS

### The First Example Embodiment

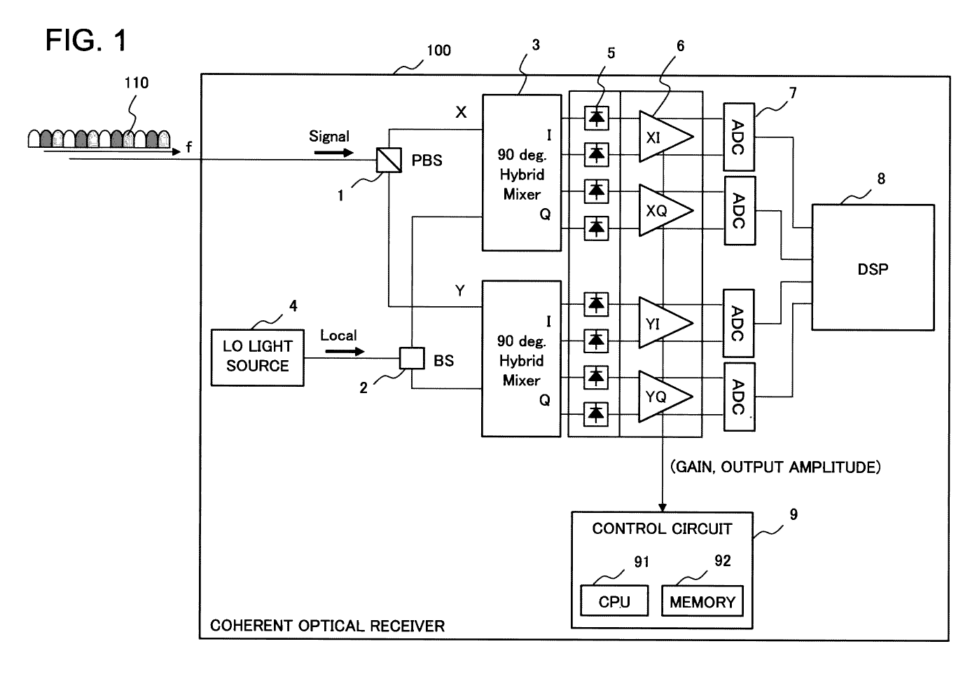

The first example embodiment of the present invention will be described with reference to a drawing. FIG. 1 is a block diagram showing a structure of a coherent optical receiver 100 of the first example embodiment of the present invention. The coherent optical receiver 100 of the first example embodiment includes a PBS (polarization beam splitter) 1, a BS (beam splitter) 2, a 90-degree hybrid 3 and a LO (local oscillation) light source 4. The coherent optical receiver 100 of the first example embodiment further includes a PD (photo diode) 5, a differential amplifier 6, an ADC (analog-digital converter) 7, a DSP (digital signal processor) 8 and a control circuit 9. Meanwhile, since the basic structure and operations of the coherent optical receiver 100 are known well, only an outline will be described about the general structure and operations below.

The coherent optical receiver 100 receives an optical signal 110 for which wavelength multiplication has been performed. The received optical signal 110 (reception beam) is separated into an X-polarized wave and a Y-polarized wave crossing at right angles to each other by the PBS 1. The separated reception beams are inputted to the different pieces of 90-degree hybrid 3, respectively. LO light outputted from the LO light source 4 is branched by the BS 2 and inputted to the different pieces of 90-degree hybrid 3, respectively. One piece of 90-degree hybrid 3 is provided for each of a reception beam corresponding to an X polarized wave and a reception beam corresponding to a Y polarized wave.

A reception beam separated by the PBS 1 into an X-polarized wave and a Y-polarized wave is combined with LO light having an optical frequency approximately identical with that of the reception beam by the 90-degree hybrid 3. In the 90-degree hybrid 3, among reception beams for which wavelength multiplication have been performed, only an optical signal having a wavelength approximately identical with that of the LO light interferes with the LO light to generate a beat signal. By controlling the wavelength of the LO light, it is possible to select from reception beams an optical signal of a wavelength (reception channel) that is desired to be received to generate a beat signal. A beat signal generated by the 90-degree hybrid 3 is received by the PD 5.

Four pieces of PD 5 are provided for the output of one piece of 90-degree hybrid 3. Two among the four pieces of PD 5 output a beat signal having a phase of I (inphase) component as a differential signal (photo electric current). The other two pieces of PD 5 output a beat signal having a phase of Q (quadrature) component as a differential signal.

The differential signal outputted from the PD 5 is inputted to the differential amplifier 6. One piece of differential amplifier 6 is provided for each of signals of an X-polarized wave I component (XI), an X-polarized wave Q component (XQ), a Y-polarized wave I component (YI) and a Y-polarized wave Q component (YQ).

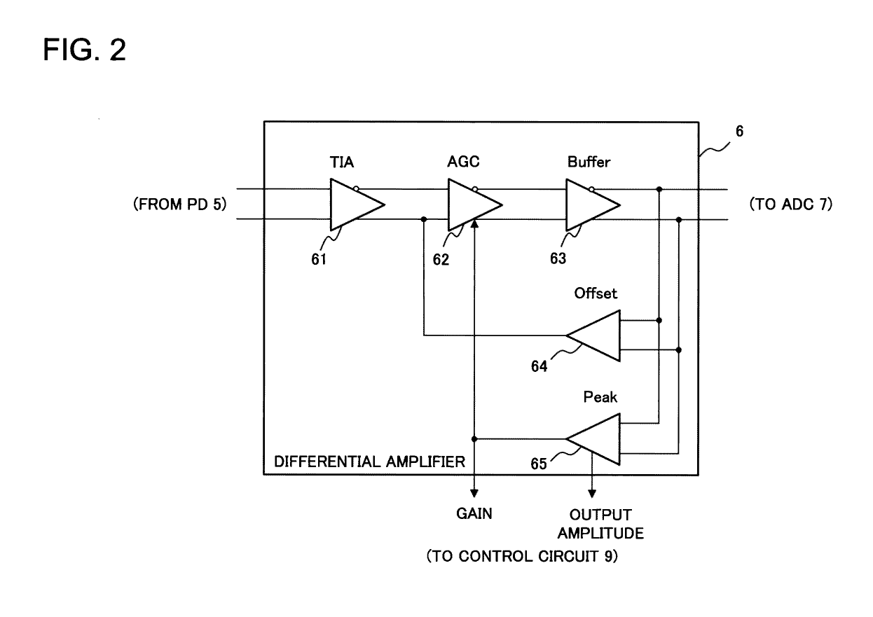

FIG. 2 is a block diagram showing a structure of the differential amplifier 6.

The differential amplifier 6 includes a TIA (trans-impedance amplifier) 61, an AGC (automatic gain control) amplifier 62, a buffer 63, an offset detector 64 and a peak detector 65. Photocurrent outputted from the PD 5 is converted into a voltage signal by the TIA 61, and is inputted to the AGC amplifier 62. The peak detector 65 detects a peak value of amplitude of a signal outputted from the buffer 63, and a gain of the AGC amplifier 62 is controlled in such a way as to make the amplitude of a detected signal be within a fixed range (AGC control). The amplitude of a signal outputted from the buffer 63 (output amplitude) and a gain of the AGC amplifier 62 are inputted to the control circuit 9. In this example embodiment, the gain of the buffer 63 is made to be 1. That is, the output amplitude of the AGC amplifier 62 and the output amplitude of the buffer 63 are equal. The maximum value of a gain of the AGC amplifier 62 is A0. Even when a gain beyond A0 is needed by AGC control, a gain of the AGC amplifier 62 is set to A0. In the coherent optical receiver 100, the optical power of an optical signal in a reception channel of the coherent optical receiver 100 is estimated based on a gain of the AGC amplifier 62 used for feedback control and the amplitude of an output signal of the buffer 63.

The differential amplifier 6 converts photocurrent outputted by the PD 5 into a voltage signal and outputs it to the ADC 7. The reception signal converted into a digital signal by the ADC 7 is outputted to the DSP 8. The DSP 8 performs calculation processing of the digital signal outputted from the ADC 7 and reproduces transmitted data.

After having been attenuated by optical loss in the PBS 1, the 90-degree hybrid 3 and on the path connecting those, the optical signal in a reception channel is mixed with the LO light and converted into a photo electric current by the PD 5.

Here, the amplitude of photo electric current outputted from the PD 5 is determined by the optical power of an optical signal in the reception channel inputted to the PD 5, the optical power of the LO light, and the quantum efficiency of the PD 5 (a conversion factor from a signal light to an electric signal). The attenuation of the PBS 1, the BS 2 and the 90-degree hybrid 3 and the quantum efficiency of the PD 5 are of a fixed nature, and thus these can be measured in advance. In addition, the optical power of LO light outputted from the LO light source 4 is easy to be measured in advance, or to be controlled in a desired numerical value also. The current-voltage transfer characteristics in the TIA 61 can be deemed to be fixed also.

On the other hand, the amplitude of a signal inputted to the AGC amplifier 62 can be known from output amplitude V of the differential amplifier 6 and gain A of the AGC amplifier 62. Then, the amplitude of the photo electric current outputted from the PD 5 can be obtained based on the amplitude of a signal inputted to the AGC amplifier 62 and the current-voltage transfer characteristics of the TIA 61. That is, relation between gain A of the differential amplifier 6 and output amplitude V of the AGC amplifier 62, and the optical power of an optical signal in a reception channel inputted to the PD 5 can be obtained. Then, finally, the optical power of an optical signal in a reception channel at the time when it has been inputted to the coherent optical receiver 100 can be obtained from output amplitude V of the differential amplifier 6 and gain A of the AGC amplifier 62 using: the above-mentioned relation; the optical power of the LO light outputted from the LO light source 4; and the respective attenuation of the PBS 1, the BS 2 and the 90-degree hybrid 3.

Or, relation between output amplitude V of the differential amplifier 6 and gain A of the AGC amplifier 62, and the optical power of an optical signal in a reception channel may be measured when the coherent optical receiver 100 is produced to store the measured data in the control circuit 9. Such measurement may be performed under different operating conditions taking the optical characteristics and the electrical characteristics of constituent elements of the coherent optical receiver 100, such as loss of optical parts and the power of LO light, as parameters. Then, the optical power of an optical signal in a reception channel can be obtained also by referring to measured data at the time of production by a numerical value of output amplitude V of the differential amplifier 6 and gain A of the AGC amplifier 62.

That is, the coherent optical receiver 100 can come to know the optical power of an optical signal in a reception channel based on an operation state of the differential amplifier 6 without selecting a received wavelength by an optical filter.

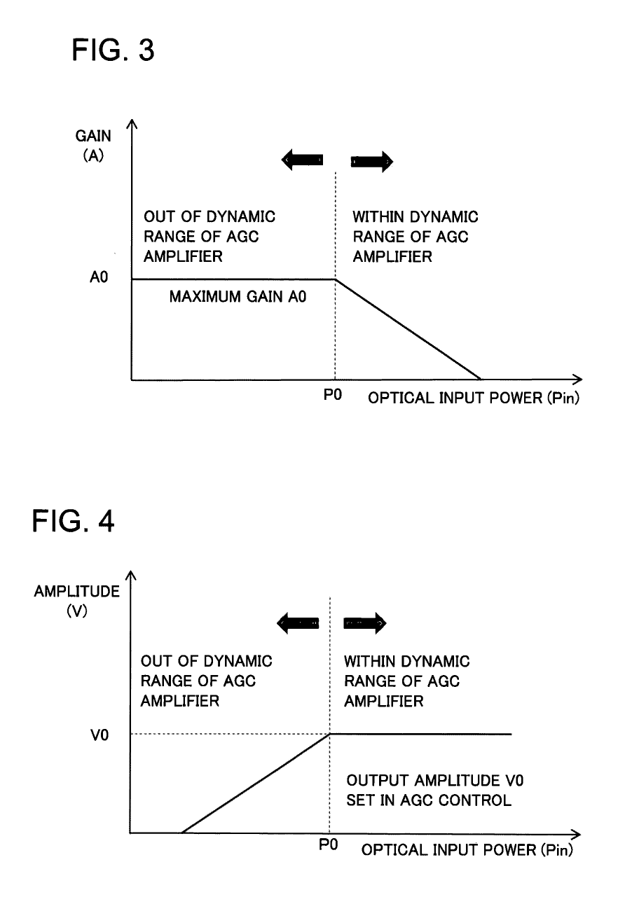

FIG. 3 is a diagram showing an example of relation between optical input power Pin and gain A of the AGC amplifier 62 in this example embodiment. Optical input power Pin is optical power of an optical signal in a reception channel at the time of being inputted to the coherent optical receiver 100. As mentioned above, the relation of FIG. 3 may be calculated based on the electrical characteristics or optical characteristics of the elements constituting the coherent optical receiver 100, or it may be measured when the coherent optical receiver 100 is produced.

P0 is the smallest optical input power required in order to obtain an output signal of a fixed amplitude (that is, a set value of an output amplitude under AGC control) V0 by AGC control of the AGC amplifier 62. In the area of Pin<P0, since the amplitude of a signal inputted to the AGC amplifier 62 is small, the amplitude of an output signal of the AGC amplifier 62 does not reach V0 although the AGC amplifier 62 operates at the maximum gain A0. In the region of Pin≧P0, the AGC amplifier 62 operates within its dynamic range.

FIG. 4 is a diagram showing an example of relation between optical input power Pin and amplitude V of an output signal of the differential amplifier 6 in this example embodiment. Optical input power Pin is the optical power of a reception channel received by the coherent optical receiver 100. Like FIG. 3, relation of FIG. 4 may be calculated based on numerical values of the characteristics of elements constituting the coherent optical receiver 100, or may be measured when the coherent optical receiver 100 is produced.

In FIG. 4, since gain A of the AGC amplifier 62 will be the maximum value A0 when optical input power Pin is less than P0, output amplitude V declines along with a fall of optical input power Pin. On the other hand, when optical input power Pin is no smaller than P0, the amplitude of an output signal of the AGC amplifier 62 will be a constant value V0 due to AGC control. That is, when Pin≧P0, optical input power Pin cannot be obtained using FIG. 4. However, in the case when Pin≧P0, optical input power Pin can be acquired from the relation between gain A and optical input power Pin shown in FIG. 3.

In addition, when optical input power Pin falls to less than P0, gain A of the AGC amplifier 62 will be a constant value of the maximum value A0 as shown in FIG. 3. That is, when it is Pin<P0, optical input power P cannot be obtained using FIG. 3. However, in the case when Pin<P0, optical input power Pin can be obtained from the relation between output amplitude V and optical input power Pin shown in FIG. 4.

Accordingly, by using both of FIG. 3 and FIG. 4, optical input power Pin can be obtained from numerical values of output amplitude V and gain

A of the AGC amplifier 62 during operation. For example, when optical input power Pin is less than P0, optical input power Pin can be obtained from output amplitude V and the relation of FIG. 4. Alternatively, optical input power Pin can be obtained by calculation using output amplitude V, gain A0 and numerical values of the electrical characteristics or optical characteristics of elements constituting the coherent optical receiver 100.

On the other hand, when optical input power Pin is no smaller than P0, optical input power Pin can be obtained from gain A acquired from the peak detector 65 and the relation of FIG. 3. Otherwise, optical input power Pin can be obtained by calculation using gain A, a setting value of amplitude V0, and numerical values of the electrical characteristics or optical characteristics of elements constituting the coherent optical receiver 100.

Whether optical input power Pin is larger than P0 or not can be judged by comparing gain A of the AGC amplifier 62 with the maximum value A0 of a gain. That is, when A<A0, it is judged that an optical input power P exceeds P0 because the output of the AGC amplifier 62 does not reach the maximum value. On the other hand, when A=A0, optical input power Pin is judged as being no more than P0.

Or, whether optical input power Pin is larger than P0 or not can be judged also by comparing output V of the AGC amplifier 62 and V0 which is the default of the output amplitude under AGC control. That is, when V=V0, optical input power Pin is judged as being no smaller than P0. On the other hand, when V<V0, optical input power Pin is judged as being less than P0.

Meanwhile, the scale of each axis of FIG. 3 and FIG. 4 is arbitrary, and the oblique line portions of the graphs are not ones indicating linear relation between the variables necessarily.

The procedure to obtain optical input power Pin described in FIG. 3 and FIG. 4 is carried out in the control circuit 9. Gain A of the AGC amplifier 62 and output amplitude V of the differential amplifier 6 are inputted to the control circuit 9. The control circuit 9 stores the maximum gain A0 of the AGC amplifier 62 and a setting value V0 of an output amplitude. The control circuit 9 obtains optical input power Pin by the above-mentioned procedure based on relation between gain A or output amplitude V and optical input power Pin.

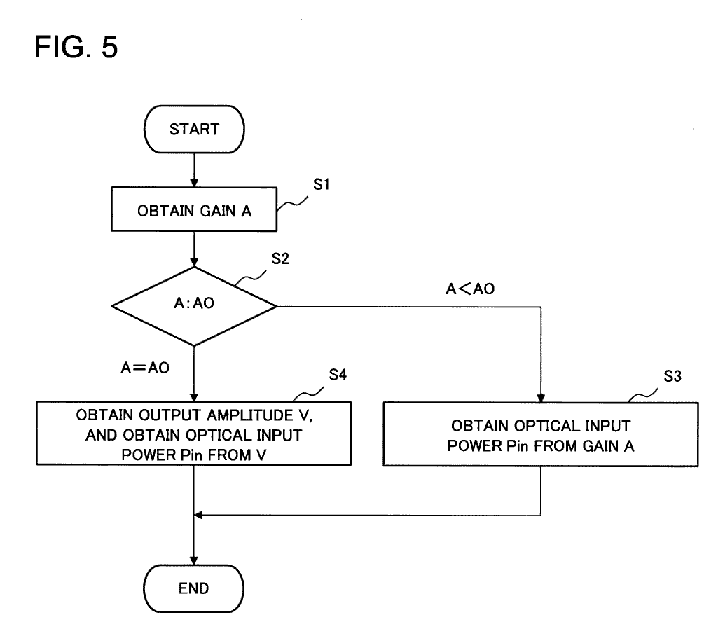

FIG. 5 is a flow chart showing an example of a procedure for the control circuit 9 to obtain optical input power Pin using the relation of FIG.

3 and FIG. 4. The control circuit 9 acquires a numerical value of gain A (Step S1 of FIG. 5), and compares the inputted gain A with the stored maximum gain A0 (S2). Then, when A<A0 (in S2: A<A0), the control circuit 9 obtains optical input power Pin from gain A using the relation of FIG. 3 because optical input power Pin exceeds P0 (S3). When A=A0 (in S2: A=A0), the control circuit 9 acquires output amplitude V and obtains optical input power Pin from the output amplitude V using the relation of FIG. 4 because optical input power Pin is no more than P0 (S4).

If whether optical input power Pin is larger than P0 or not is judged by comparison of output amplitude V and a setting value V0, Step S1 of FIG. 5 is changed to a procedure to acquire output amplitude V, and the procedure of Step S2 is changed to a procedure to compare V and V0. Then, when V=V0 in the changed Step S2, the control circuit 9 acquires gain A and advances to Step S3, and when V<V0, advances to Step S4.

The control circuit 9 may include a CPU (central processing unit) 91 and a memory 92. The memory 92 is a non-volatile storage medium to store a program fixedly, and is a non-volatile semiconductor memory, for example, but not limited to this. The CPU 91 may perform the function of the coherent optical receiver 100 mentioned above by executing a program stored in the memory 92. The memory 92 may memorize measured data or calculation result of relation between output amplitude V of the differential amplifier 6 and gain A of the AGC amplifier 62, and optical power Pin of an optical signal in a reception channel. In addition, the memory 92 may memorize the setting value V0 of the output amplitude of the differential amplifier 6 on the occasion of AGC control and the maximum gain A0 of the AGC amplifier 62.

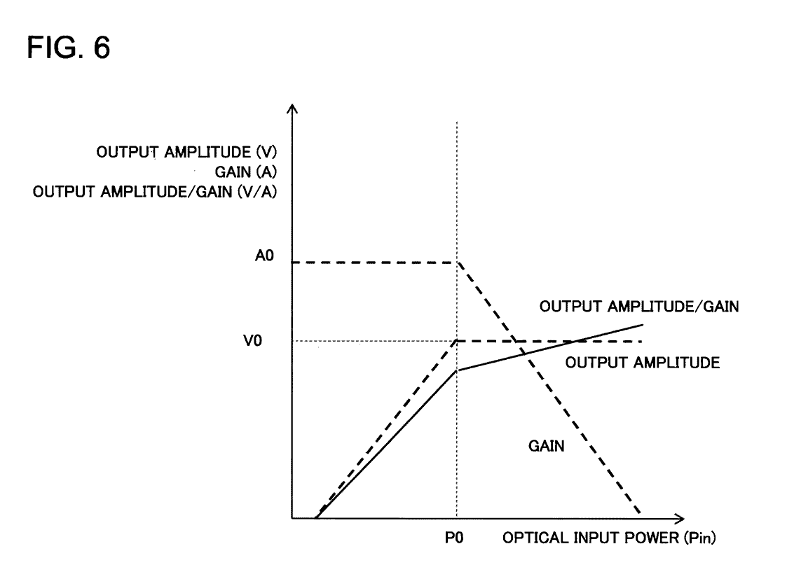

FIG. 6 is a diagram showing an example of relation between optical input power Pin, and amplitude V, gain A and a numerical value (V/A), which is obtained by dividing amplitude by a gain, in the first example embodiment. The thick dashed lines of FIG. 6 indicate amplitude V and gain A, and the solid line indicates V/A. FIG. 6 indicates diagrams shown in FIG. 3 and FIG. 4 in one diagram, and also describes numerical values (V/A) obtained by dividing amplitude V by gain A. The scale of each axis of FIG. 6 is arbitrary, and oblique line portions of the graph are not necessarily ones indicating linear relation between the variables.

By storing the data of the solid line (output amplitude/gain) of FIG. 6 in the control circuit 9, and, obtaining V/A from amplitude V and gain A obtained at the time of use and referring to the data of the solid line of FIG. 6, optical power Pin of an optical signal in a reception channel can be acquired. The data of the solid line of FIG. 6 may be calculated based on the optical characteristics and electrical characteristics of elements constituting the coherent optical receiver 100 like the relation of FIG. 3 and FIG. 4, or may be obtained from the relation between amplitude V, gain A and optical input power Pin measured when the coherent optical receiver 100 is produced.

By such procedure, the coherent optical receiver 100 of the first example embodiment can measure optical input power Pin of an optical signal in a reception channel even when the AGC amplifier circuit 62 is operating outside its dynamic range, that is, even when optical input power Pin is in a low level that is an out-of-bounds of AGC control. The reason of this is that, when optical input power Pin is in a low level that is an out-of-bounds of AGC control, the coherent optical receiver 100 obtains optical input power Pin using output amplitude V of the AGC amplifier 62.

Accordingly, the coherent optical receiver 100 of the first example embodiment exerts an effect that the optical power of a received signal can be detected correctly in a wide range of optical input power. The coherent optical receiver 100 of the first example embodiment can measure the optical power of a received signal without selecting a reception channel using an optical filter.

As a warning of an optical receiver, LOS (loss of signal) is used. When the optical power of an optical signal is less than a predetermined optical power, LOS is sent. Since the coherent optical receiver 100 of the first example embodiment can measure the input level of an optical signal over a wide range, it also has an effect that a detection range of LOS can be expanded.

### (Modification of the First Example Embodiment)

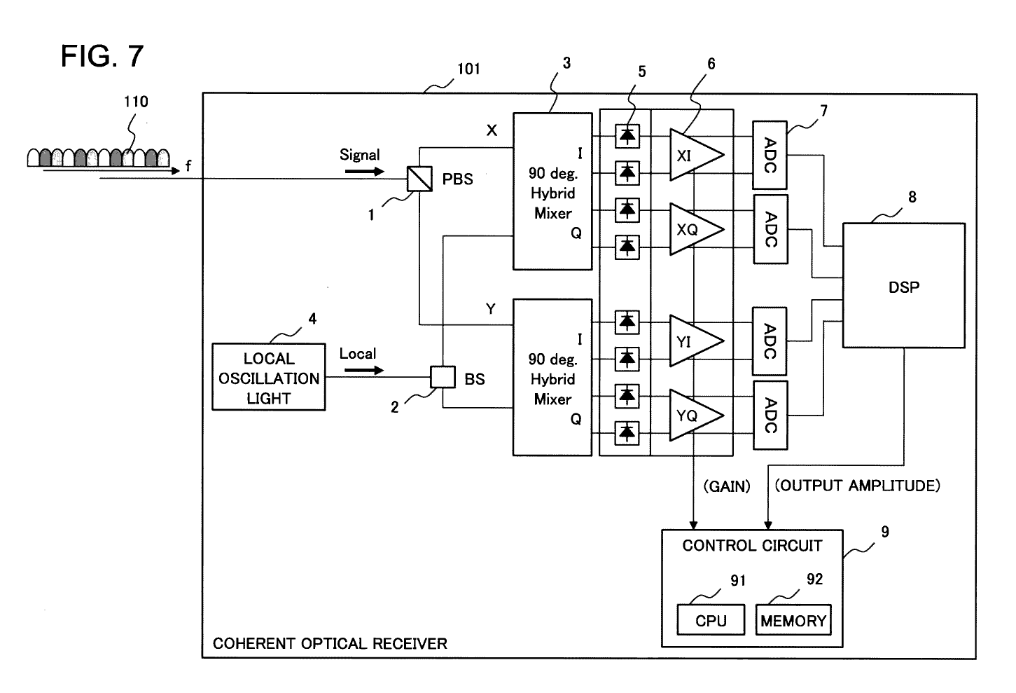

FIG. 7 is a block diagram showing a structure of a coherent optical receiver 101 which is a modification of the first example embodiment. In the coherent optical receiver 100 of the first example embodiment, output amplitude V of the differential amplifier 6 is used. However, the DSP 8 may output the data of output amplitude used inside the DSP 8 to the control circuit 9. The same effect as that of the first example embodiment is obtained by the control circuit 9 using data inputted from the DSP 8 by converting it into output amplitude V.

### The Second Example Embodiment

An optical receiver of the second example embodiment includes a reception unit, an amplifying unit and a control unit. An optical receiver of the second example embodiment includes a part of the structure of the coherent optical receiver 100 of the first example embodiment shown in FIG. 1.

The reception unit receives an optical signal to which coherent modulation has been performed, and outputs a first electric signal converted from the optical signal. For example, the function of the reception unit is performed by the part including the PBS 1, the BS 2, the 90-degree hybrid 3, the LO light source 4 and the PD 5 of FIG. 1. The reception unit receives an optical signal to which coherent modulation has been performed, and makes the optical signal interfere with LO light to output a beat signal generated by the interference to the amplifying unit as a first electric signal.

The first electric signal is amplified by the amplifying unit. The amplifying unit amplifies the first electric signal and outputs the first electric signal that has been amplified as a second electric signal.

The control unit obtains the optical power of the optical signal based on the relation between optical power of an optical signal in the reception unit, and a gain of the amplifying unit and amplitude of the second electric signal. Relation between the optical power of an optical signal in the reception unit, and a gain of the amplifying unit and amplitude of the second electric signal is measured when the optical receiver is produced, and the measurement result has been stored in the control unit. Alternately, relation between the optical power of an optical signal in a reception unit, and a gain of an amplifying unit and amplitude of the second electric signal may be obtained by calculation using optical characteristics and the electrical characteristics (such as loss, output light power of LO light source, conversion efficiency of a light receiving element and amplifying characteristics of an amplifier) of elements of which an optical receiver is composed. Or, the control unit may acquire a gain of the amplifying unit and amplitude of the second electric signal from the amplifying unit, and divide the amplitude of the second electric signal by the gain of the amplifying unit to obtain the amplitude of the first electric signal. Then, the control unit may obtain the optical power of an optical signal from the relation between the optical power of an optical signal and amplitude of the first electric signal measured in advance.

An optical receiver of the second example embodiment having such structure can come to know the optical power of a received signal correctly within a wide range of optical input power. The reason of this is that the control unit obtains the optical power of an optical signal based on at least one of the amplitude of the second electric signal outputted from an amplifying unit and a gain of the amplifying unit regardless of the amplitude of the first electric signal being within or an out-of-bounds of the range of the dynamic range of the amplifying unit.

### The Third Example Embodiment

An optical receiver of the third example embodiment includes a reception unit, an amplifying unit and a control unit. In an optical receiver of the third example embodiment, an optical signal received by the reception unit is not limited to an optical signal for which coherent modulation has been performed.

That is, a reception unit of the optical receiver of the third example embodiment receives an optical signal and outputs a first electric signal converted from the optical signal. For example, the function of the reception unit is performed by PD. The structure of an optical receiver 3 of the third example embodiment besides above is similar to an optical receiver of the second example embodiment.

An optical receiver of the third example embodiment having such structure can also come to know the optical power of a received signal correctly within a wide range of optical input power. The reason of this is that the control unit obtains the optical power of an optical signal based on at least one of amplitude of the second electric signal outputted from the amplifying unit and a gain of the amplifying unit regardless of the amplitude of the first electric signal being within or an out-of-bounds of the range of the dynamic range of the amplifying unit.

Although the present invention has been described with reference to the example embodiments above, the present invention is not limited to the above-mentioned example embodiments. Various changes which a person skilled in the art can understand can be made in the composition and details of the present invention within the scope of the present invention.

For example, in the first and second example embodiments, there have been described example embodiments in which the present invention is applied to a coherent optical receiver. However, as is the third example embodiment, the present invention is also applied to an optical receiver besides a coherent optical receiver. As a result, the present invention also exerts an effect that even a general optical receiver can come to know the optical power of a received signal correctly in a wide range of optical input power.

This application claims priority based on Japanese application Japanese Patent Application No. 2014-121490, filed on Jun. 12, 2014, the disclosure of which is incorporated herein in its entirety by reference.

### REFERENCE SIGNS LIST

100, 101 Coherent optical receiver

110 Optical signal

1 PBS (polarization beam splitter)

2 BS (beam splitter)

3 90-degree hybrid

4 LO (local oscillation) light source

5 PD (photo diode)

6 Differential amplifier

61 TIA (trans-impedance amplifier)

62 AGC (automatic gain control) amplifier

63 Buffer

64 Offset detector

65 Peak detector

7 ADC (analog-digital converter)

8 DSP (digital signal processor)

9 Control circuit

91 CPU (central processing unit)

92 Memory

1. An optical receiver, comprising:
a receiver configured to receive an optical signal having undergone coherent modulation to output a first electric signal converted from the optical signal;
an amplifier configured to amplify the first electric signal to output the first electric signal having been amplified as a second electric signal; and
a controller configured to obtain an optical power of the optical signal based on relation between optical power of the optical signal in the receiver and at least one of a gain of the amplifier and amplitude of the second electric signal.

2. The optical receiver according to claim 1, wherein the controller:
obtains, when the gain of the amplifier indicates a maximum gain, the optical power of the optical signal based on the maximum gain and amplitude of the second electric signal, and
obtains, when amplitude of the second electric signal indicates a fixed amplitude, the optical power of the optical signal based on the gain of the amplifier and the fixed amplitude.

3. The optical receiver according to claim 1, wherein
the controller stores relation between optical power of the optical signal, and the gain of the amplifier and amplitude of the second electric signal at a time of production of the optical receiver.

4. The optical receiver according to claim 1, further comprising:
an analog-digital converter configured to convert the second electric signal inputted from the amplifier into a digital signal to output the digital signal; and
a signal processor configured to process the digital signal inputted from the analog-digital converter to reproduce data transmitted by the optical signal,
wherein
the signal processor outputs a signal corresponding to the amplitude of the second electric signal to the controller, and the controller obtains amplitude of the second electric signal based on the signal corresponding to the amplitude of the second electric signal.

5. An optical receiving method, comprising:
receiving an optical signal having undergone coherent modulation;
outputting a first electric signal converted from the optical signal;
amplifying the first electric signal;
outputting the first electric signal having been amplified as a second electric signal; and
obtaining an optical power of the optical signal based on relation between optical power when receiving the optical signal, and at least one of a gain when amplifying the first electric signal and amplitude of the second electric signal.

6. A non-transitory computer readable recording medium storing a control program when executed by a computer of an optical receiver that causes the computer of the optical receiver to perform:
a process of receiving an optical signal having undergone coherent modulation;
a process of outputting a first electric signal converted from the optical signal;
a process of amplifying the first electric signal;
a process of outputting the first electric signal having been amplified as a second electric signal; and
a process of obtaining optical power of the optical signal based on relation between optical power when receiving the optical signal, and at least one of a gain when amplifying the first electric signal and amplitude of the second electric signal.

7. The optical receiver according to claim 2, wherein
the controller stores relation between optical power of the optical signal, and the gain of the amplifier and amplitude of the second electric signal at a time of production of the optical receiver.

8. The optical receiver according to claim 2, further comprising:
an analog-digital converter configured to convert the second electric signal inputted from the amplifier into a digital signal to output the digital signal; and
a signal processor configured to process the digital signal inputted from the analog-digital converter to reproduce data transmitted by the optical signal,
wherein
the signal processor outputs a signal corresponding to the amplitude of the second electric signal to the controller, and the controller obtains amplitude of the second electric signal based on the signal corresponding to the amplitude of the second electric signal.

9. The optical receiver according to claim 3, further comprising:
an analog-digital converter configured to convert the second electric signal inputted from the amplifier into a digital signal to output the digital signal; and
a signal processor configured to process the digital signal inputted from the analog-digital converter to reproduce data transmitted by the optical signal,
wherein
the signal processor outputs a signal corresponding to the amplitude of the second electric signal to the controller, and the controller obtains amplitude of the second electric signal based on the signal corresponding to the amplitude of the second electric signal.

10. The optical receiver according to claim 7, further comprising:
an analog-digital converter configured to convert the second electric signal inputted from the amplifier into a digital signal to output the digital signal; and
a signal processor configured to process the digital signal inputted from the analog-digital converter to reproduce data transmitted by the optical signal,
wherein
the signal processor outputs a signal corresponding to the amplitude of the second electric signal to the controller, and the controller obtains amplitude of the second electric signal based on the signal corresponding to the amplitude of the second electric signal.

11. The optical receiving method according to claim 5, further comprising:
obtaining, when the gain of the amplifying is a maximum gain, the optical power of the optical signal based on the maximum gain and amplitude of the second electric signal; and
obtaining, when amplitude of the second electric signal is a fixed amplitude, the optical power of the optical signal based on the gain of the amplifying and the fixed amplitude.

12. The optical receiving method according to claim 5, further including:
storing relation between optical power of the optical signal, and the gain of the amplifying and amplitude of the second electric signal at a time of production of the optical receiver.

13. The optical receiving method according to claim 5, further comprising:
converting the second electric signal that has been amplified into a digital signal to output the digital signal; and
processing the digital signal being undergone the converting to reproduce data transmitted by the optical signal,
wherein
the processing includes outputting a signal corresponding to the amplitude of the second electric signal for the controlling, and the controlling uses amplitude of the second electric signal based on the signal corresponding to the amplitude of the second electric signal.

14. The optical receiving method according to claim 11, further including:
storing relation between optical power of the optical signal, and the gain of the amplifying and amplitude of the second electric signal at a time of production of the optical receiver.

15. The optical receiving method according to claim 11, further comprising:
converting the second electric signal that has been amplified into a digital signal to output the digital signal; and
processing the digital signal being undergone the converting to reproduce data transmitted by the optical signal,
wherein
the processing includes outputting a signal corresponding to the amplitude of the second electric signal for the controlling, and the controlling uses amplitude of the second electric signal based on the signal corresponding to the amplitude of the second electric signal.

16. The optical receiving method according to claim 12, further comprising:
converting the second electric signal that has been amplified into a digital signal to output the digital signal; and
processing the digital signal being undergone the converting to reproduce data transmitted by the optical signal,
wherein
the processing includes outputting a signal corresponding to the amplitude of the second electric signal for the controlling, and the controlling uses amplitude of the second electric signal based on the signal corresponding to the amplitude of the second electric signal.

17. The optical receiving method according to claim 14, further comprising:
converting the second electric signal that has been amplified into a digital signal to output the digital signal; and
processing the digital signal being undergone the converting to reproduce data transmitted by the optical signal,
wherein
the processing includes outputting a signal corresponding to the amplitude of the second electric signal for the controlling, and the controlling uses amplitude of the second electric signal based on the signal corresponding to the amplitude of the second electric signal.

18. The non-transitory computer readable recording medium storing the control program according to claim 6, when executed by the computer of the optical receiver, the control program further causes the computer of the optical receiver to perform:
a process of obtaining, when the gain of the amplifying is a maximum gain, the optical power of the optical signal based on the maximum gain and amplitude of the second electric signal; and
a process of obtaining, when amplitude of the second electric signal is a fixed amplitude, the optical power of the optical signal based on the gain of the amplifying and the fixed amplitude.

19. The non-transitory computer readable recording medium storing the control program according to claim 6, when executed by the computer of the optical receiver, the control program further causes the computer of the optical receiver to perform:
a process of storing relation between optical power of the optical signal, and the gain of the amplifying and amplitude of the second electric signal at a time of production of the optical receiver.

20. The non-transitory computer readable recording medium storing the control program according to claim 6, when executed by the computer of the optical receiver, the control program further causes the computer of the optical receiver to perform:
a process of converting the second electric signal that has been amplified into a digital signal to output the digital signal; and
a process of processing the digital signal being undergone the converting to reproduce data transmitted by the optical signal,
wherein
the process of processing the digital signal includes outputting a signal corresponding to the amplitude of the second electric signal for the process of controlling, and the process of controlling uses amplitude of the second electric signal based on the signal corresponding to the amplitude of the second electric signal.
